(19) United States
(12) Patent Application Publication
(10) Pub. No.: US 2008/0198488 A1
(43) Pub. Date: Aug. 21, 2008

(54) DATA DUPLICATOR

(75) Inventors: Hirotoshi Shimada, Ome-shi (JP); Hirofumi Hari, Kodaira-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation, Tokyo (JP)

(21) Appl. No.: 12/033,755

(22) Filed: Feb. 19, 2008

(30) Foreign Application Priority Data
Feb. 21, 2007 (JP) 2007-040170

(51) Int. Cl. G11B 5/86

(52) U.S. Cl. 360/15

(57) ABSTRACT

A data duplicator capable of copying data to a plurality of types of disk. Data are read from a source disk which serves as a source of duplication, and the read data are temporarily saved as FAT data in a hard disk drive. The type of a target disk which is loaded on a DVD drive and which serves as a destination of duplication is determined, and the disk is converted into a file system format conforming to the type of the disk, and the data are copied to the target disk.

### PRIORITY INFORMATION

This application claims priority to Japanese Patent Application No. 2007-040170 filed on Feb. 21, 2007, which is incorporated herein by reference in its entirety.

### BACKGROUND

1. Technical Field

The present invention relates to a data duplicator, and more particularly to a technique for copying data from a source disk—a source of duplication—to a target disk—a destination of duplication—by way of a hard disk drive.

2. Related Art

A technique for copying data from a source disk drive to a target disk drive by use of one disk drive unit has hitherto been put forward.

JP 2000-357370 A provides disclosures about reading a title recorded in a disk when a disk loaded in a drive is a DVD-Audio, outputting the thus-read title to a host computer, and storing the title in the form of a file of temporary save format in a hard disk drive of the host computer; and descriptions about recording a title stored in a hard disk drive in DVD-RAM when a disk loaded in the drive is DVD-RAM, reading a title key from a DVD-Audio without storing it in the hard disk drive, storing the thus-read title key in EEPROM, and subsequently recording the title key in the DVD-RAM. There are also disclosures about, when data read from the DVD-Audio are stored in the hard disk drive, creating below a root directory a directory for storing data files of read-only format and a data file of readable/writable format and a directory for storing files for managing files of temporary save format; and storing data files of temporary save format and an attribute information table. The patent publication also provides descriptions of the attribute information table being a table that associates with each other file path information showing locations of files corresponding to digital contents in a hard disk drive, file attributes showing attributes of files storing the digital contents, and the date and time when the digital contents were stored in the hard disk drive.

JP 2003-36594 A provides disclosures about acquiring disk information and track information about a source disk loaded in a CD-RW drive; acquiring disk information about a target disk; reading data pertaining to the source disk after setting write conditions into the target disk and saving the thus-read data in a hard disk drive; and writing the data into the target disk set in place of the source disk. The patent publication also provides disclosures about reading data from a CD serving as a source of duplication; saving the data in the form of an image in the hard disk drive; and writing the data into the target disk.

JP 2004-118986 A provides disclosures about an AV-encoding section simultaneously encoding, in a plurality of types of recording formats, a video signal supplied from the outside and storing the encoded signals into a hard disk drive; checking the type of a target disk at the time of duplication; selecting record data of an appropriate data format from the record data stored in the hard disk drive; and recording the selected record data in a target disk.

However, according to the related-art technique, data in the source disk are temporarily saved, as they are, in the hard disk drive, and the thus—saved data are written into the target disk. Therefore, data cannot be copied unless the source disk and the target disk are of the same file system.

In the meantime, according to the other related-art technique, the data are simultaneously encoded in the plurality of types of recording formats, and a recording format conforming to the type of the target disk is selected. Hence, duplication can be performed regardless of the type of the target disk. However, since the data are simultaneously encoded in the plurality of types of recording formats, the capacity of the hard disk drive required for the duplication of one piece of contents is increased, which in turn results in a substantial decrease in the volume of contents that can be stored in the hard disk drive. Furthermore, encoders conforming in number to recording formats are required, which invites complication of a system and an increase in cost.

### SUMMARY

The present invention provides a device capable of copying data from a disk to another disk by means of a simple configuration.

The present invention is directed toward a data duplicator for copying data from a source disk serving as a source of duplication to a target disk serving as a destination of duplication, the duplicator comprising:

an optical disk drive;

a hard disk drive; and

a control unit that reads data from the source disk loaded on the optical disk drive; that stores the data into the hard disk drive by means of a first format; and that, after storage of the data, converts the first format into a second format conforming to a type of the target disk loaded on the optical disk drive and writes the data into the target disk.

In an embodiment of the present invention, the first format is an FAT, and ISO9660 or a UDF is automatically selected as the second format according to the type of the target disk.

According to the present invention, data can be automatically duplicated from the source disk to the destination disk in compliance with a variety of disks.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following drawings, wherein:

FIG. 1 is a block diagram of a digital master recorder of an embodiment of the present invention; and

FIG. 2 is a flowchart of processing of the embodiment.

### DETAILED DESCRIPTION

An embodiment of the present invention will be described hereunder by reference to the drawings while a digital master recorder is taken as an example data duplicator.

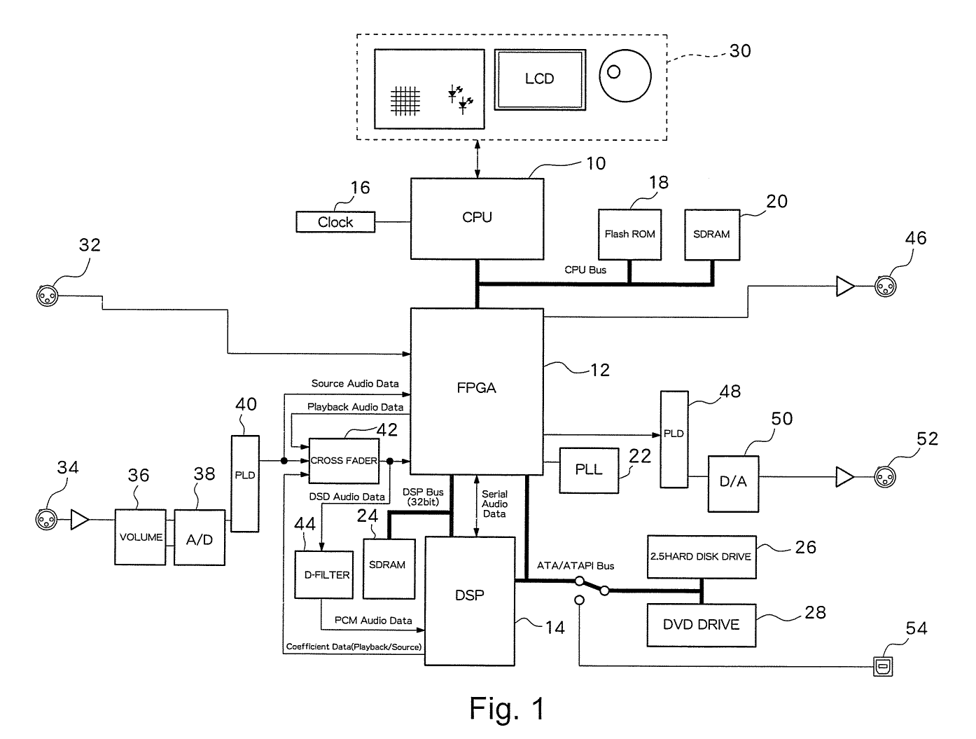

FIG. 1 shows the configuration of a digital master recorder of an embodiment. The digital master recorder has external input terminals; namely, an analogue input terminal and a digital input terminal, and records an audio signal supplied by way of the external input terminal onto a CD-R/RW, a DVD±R, or a DVD±RW. Further, the digital master recorder has a built-in hard disk drive, and can record audio data also in the hard disk drive.

In FIG. 1, the digital master recorder has a CPU 10, an FPGA (Field Programmable Gate Array; that is, a programmable LSI) 12, a DSP 14, and a hard disk drive 26 and a DVD drive 28, as well.

The CPU 10 operates in accordance with a clock signal from a clock 16 and executes various processing operations pursuant to a command from a user interface block 30. A processing program for the CPU 10 is stored in flash ROM 18, and data processed by the CPU are stored in SDRAM 20 serving as work memory. The user interface block 30 has various keys, display LEDs for enabling visual ascertainment of an operating status, an LCD, and a rotary encoder. The rotary encoder is used for volume control, menu selection, and the like. The user interface block 30 is provided on a front panel of the digital master recorder.

The FPGA 12 is supplied with a digital audio signal from a digital input terminal 32, and the digital audio signal is supplied from an analogue input terminal 34 by way of a volume 36, an A/D 38, and a PLD (Programmable Logic Device) 40. The FPGA 12 operates in response to a clock signal from a PLL 22; serially exchanges audio data with the DSP 14; and outputs a processing result to a digital output terminal 46 or to an analogue output terminal 52 by way of a PLD 48 and a D/A 50. The CPU 10 stores data read from a source disk by the FPGA 12 into the hard disk drive as an FAT file, and converts the data read from the hard disk drive into a file format conforming to the type of a target disk loaded in the DVD drive 28 and writes the thus-converted data into the target disk. As to conversion of a file format, data are supplied to the DSP 14, and the DSP 14 performs conversion of the file format.

The CPU 10 converts the format of the data read by way of the FPGA 12 by use of the SDRAM 24 serving as work memory. Format conversion is determined according to the type of the target disk as mentioned above. A format conversion scheme may also be automatically selected according to the type of the target disk, or a format conversion scheme selected by the user by use of the user interface block 30 may also be used. When the format conversion scheme is automatically selected, the CPU 10 acquires from the DVD drive 28 information about the type of the target disk and sets a format conversion scheme (a file system to be converted). When the format conversion scheme is manually selected, the information input by way of the user interface block 30 is supplied to the CPU 10, whereupon the format conversion scheme (a file system to be converted) is set. The DSP 14 performs processing for converting a data format of an audio file, such as conversion of DSD audio data into PCM audio data. The DSP 14 also subjects another audio signal to various effect processing operations and supplies the processed signal to the FPGA 12. A fader 42 and a D-filter 44 are also used for various processing operations. The D-filter 44 is used at the time of generation of meter display data or conversion of DSD audio data into PCM audio data.

The hard disk drive 26 is of, for example, a 2.5-inch type and stores data in the form of a file system format of FAT-32.

The DVD drive 28 is a combo drive capable of driving a CD and a DVD and can drive a CD-R/RW, a DVD±R, and a DVD±RW. Formats of the respective disks are as follows:

CD-R/RW: CD-DA

DVD±R: ISO9660

DVD±RW: UDF 1.5

File formats of the respective disks are also as follows:

CD-R/RW: CD-DA

DVD±R, DVD±RW (PCM): BWF

DVD±R, DVD±RW (DSD): DSDIFF

A USB terminal 54 is provided on a rear panel of the digital master recorder and connected to a personal computer.

In the configuration such as that mentioned above, when the user selects COPY by use of a function key or a rotary encoder of the user interface block 30, the CPU 10, the FPGA 12, and the DSP 14 read data from the source disk loaded in the DVD drive 28; stores the thus-read data in the hard disk drive 26; subjects the file system of the data stored in the hard disk drive 26 to format conversion; and writes the data onto a target disk loaded in the DVD drive 28, thereby effecting copying operation.

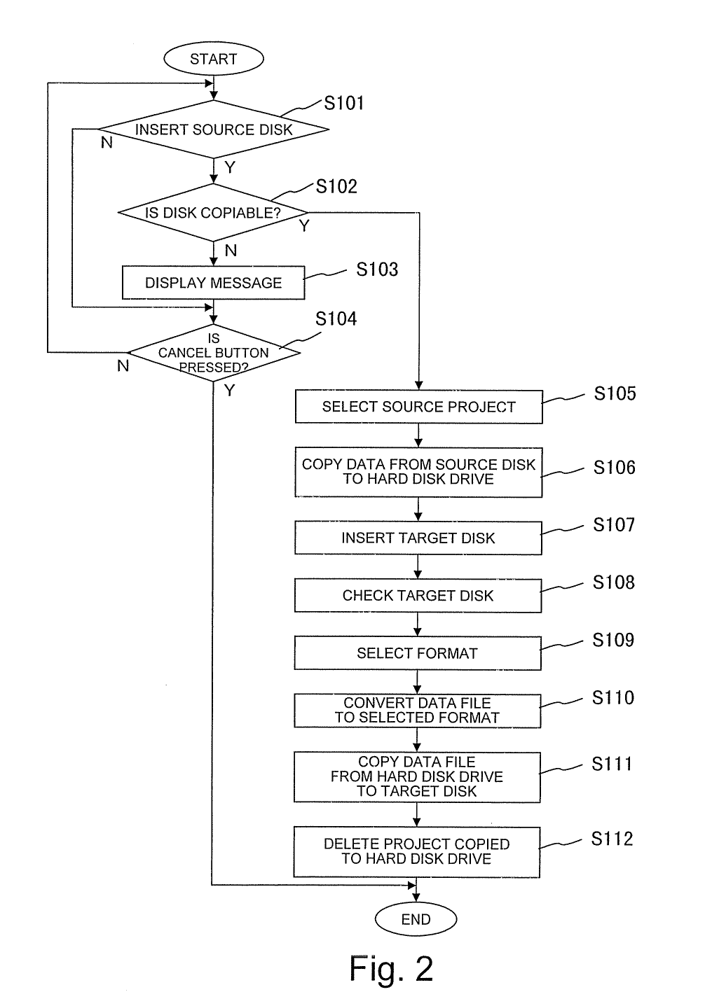

FIG. 2 shows a flowchart of copying operation of the present embodiment. First, when the user sets a source disk serving as a source of duplication on the DVD drive 28 (S101), a check is made as to whether or not the disk is a copiable disk (S102). When the disk is determined to be a copiable disk, processing proceeds to selection of a source project to be copied (S105). In contrast, when the disk is determined to be an uncopiable disk in step S102, a message showing that the disk is uncopiable or a message prompting replacement of a source disk is displayed (S103), and a disk tray is ejected. When a cancel button is pressed at this time (S104), processing ends. Processing returns to step S105. When the user selects a project to be copied by use of the function key or the rotary encoder of the user interface block 30, data are read from the source disk on a per-selected-project basis, and the thus-read data are copied to the hard disk drive 26 (S106). The project includes a predetermined number of files; for example, 99 files, and the user can select a file from the selected project. When the file is copied to the hard disk drive 26, a temporary directory (¥temp) is created below a root directory, and data files are saved in the temporary directory.

When copying of data into the hard disk drive 26 is completed, the source disk serving as the source of duplication is unloaded, and a target disk serving as a destination of duplication is loaded in the DVD drive 28 (S107). When the target disk is loaded, the type of the target disk is ascertained (S108), and the disk is formatted in compliance with the type of the target disk (S109). The type of the target disk can be read from a lead-in area. A one-to-one correspondence exists between the type of the target disk and the format as mentioned above. Therefore, the CPU 10 or the FPGA 12 can automatically select a format according to the type of the target disk. The type of the target disk and the format information are stored in the ROM 18 as a table, and a format conforming to the type of the target disk is selected by reference to the table. Naturally, in the great majority of cases, the user ascertains the type of the target disk loaded in the DVD drive 28, and hence the user may also select and input a format by way of the user interface block 30. When the format conforming to the type of the target disk is selected, the data file stored in the hard disk drive 26 is converted into the selected format (S110), and the data file is copied from the hard disk drive 26 to the target disk (S111). After copying of the data file, the project stored in the hard disk drive 26 is deleted (S112). The project stored in the hard disk drive 26 may also be left as-is without being deleted. As a result, temporarily-saved data can be read directly from the hard disk drive 26 for other than the purpose of copying. However, in a case where the temporarily-saved data are left in the hard disk drive 26 and where data are copied from the source disk to the target disk, when a directory of the same designation (i.e., the temporary directory) is present in the hard disk drive 26, copying of the data to the hard disk drive 26 becomes impossible. Therefore, old data must be deleted at the time of commencement of copying operation. Therefore, a desirable configuration is to enable the user to select, as needed, whether or not the project having already copied to the target disk is deleted from the hard disk drive 26.

Next, specific format conversion will be described more specifically. It is assumed that the source disk is taken as A; that the target disk is taken as B; and that copying of data from A to B is expressed by A→B.

CD-R/RW→CD-R/RW (1)

Both disks have a CD-DA format, and format conversion is not required. Data read from the source disk are copied as image data to the hard disk drive 26. Subsequently, the image data are read from the hard disk drive 26 and written onto the target disk.

CD-R/RW→DVD±R (2)

A CD has a CD-DA format, whiles a DVD±R has a format ISO9660+BWF, and hence format conversion is required. Audio data are copied as a 44.1-kHz, 24-bit WAV file from the source disk to the hard disk drive 26. At the time of copying operation, a temporary directory is created, and the file is saved in the directory. The target disk is formatted by means of the file system ISO9660, and data are written onto the disk. Format conversion includes conversion of a WAV file into a BWF file or a DSDIFF file.

CD-R/RW→DVD+RW (3)

A CD has a CD-DA format, whereas a DVD±RW has a UDF1.5+BWF format, and hence format conversion is required. Audio data are copied as a 44.1-kHz, 24-bit WAV file from the source disk to the hard disk drive 26. At the time of copying operation, a temporary directory is created, and the file is saved in the directory. The target disk is formatted by means of the file system UDF1.5, and data are written onto the disk. Format conversion includes conversion of a WAV file into a BWF file or a DSDIFF file. When the target disk is not formatted, the target disk is formatted in the UDF1.5 at a point in time when the target disk is loaded prior to copying operation.

DVD÷R→CD-R/RW (4)

Data are read from the source disk on a per-project basis, and the thus-read data are copied to the hard disk drive 26. At the time of copying operation, a temporary directory is created, and the data are stored in the directory. An image file for CD-DA use is created, and the thus-created file is written into the target disk.

DVD±R→DVD±R (5)

Data are read from the source disk on a per-project basis, and the thus-read data are copied to the hard disk drive 26. At the time of copying operation, a temporary directory is created, and the data are stored in the directory. A target disk is formatted by the file system ISO9660, and the data are written into the disk.

DVD±R→DVD±RW (6)

Data are read from the source disk on a per-project basis, and the thus-read data are copied to the hard disk drive 26. At the time of copying operation, a temporary directory is created, and the data are stored in the directory. A target disk is formatted by the file system UDF1.5, and the data are written into the disk.

DVD±RW→CD-R/RW (7)

Data are read from the source disk on a per-project basis, and the thus-read data are copied to the hard disk drive 26. At the time of copying operation, a temporary directory is created, and the data are stored in the directory. An image file for CD-DA use is created, and the thus-created file is written into the target disk.

DVD±RW→DVD±R (8)

Data are read from the source disk on a per-project basis, and the thus-read data are copied to the hard disk drive 26. At the time of copying operation, a temporary directory is created, and the data are stored in the directory. A target disk is formatted by the file system ISO9660, and the data are written into the disk.

DVD±RW→DVD±RW (9)

Data are read from the source disk on a per-project basis, and the thus-read data are copied to the hard disk drive 26. At the time of copying operation, a temporary directory is created, and the data are stored in the directory. A target disk is formatted by the file system UDF1.5, and the data are written into the disk.

In the present embodiment, the type of the target disk is determined, whereupon a file system used for formatting is automatically selected. Therefore, even when the type of the target disk is replaced in midstream, copying of data can be performed continually. Copying data to target disks of different types can be speeded up.

In the present embodiment, storing data as FAT data in the hard disk drive 26 enables direct reading of temporarily-saved data from the hard disk drive 26 for the purpose other than copying. Further, conversion of the format of the data structure is not performed, and hence copy processing can be speeded up.

In the present embodiment, copying of data from an arbitrary source disk to an arbitrary target disk is enabled. However, direct copying of audio data input by way of the external input terminal into the hard disk drive 26 or onto a CD-R/RW or DVD±RW may also be enabled, and limitations may also be imposed so as to allow recording of only a project from the hard disk drive 26 to a DVD±R. The same also applies to a case where audio data input by way of the external input terminal are stored in the hard disk drive 26 and where the thus-stored data are recorded on a CD or a DVD. In the case of the CD-R/RW, an image file for use with a CD-DA format is created, and the thus-created file is written into the CD. In the case of the DVD±R, the disk is formatted by means of the file system ISO9660, and the file is written into the DVD±R. In the case of the DVD±RW, the disk is formatted by means of the file system UDF1.5, and it is better to write the file into the DVD±RW.

Although the present embodiment has described duplication of data by means of taking the digital master recorder by way of example, the present invention can also be applied to; for example, an optical disk drive incorporated in a personal computer.

What is claimed is:

1. A data duplicator for copying data from a source disk serving as a source of duplication to a target disk serving as a destination of duplication, the duplicator comprising:
an optical disk drive;
a hard disk drive; and
a control unit that reads data from the source disk loaded on the optical disk drive; that stores the data into the hard disk drive by means of a first format; and that, after storage of data, converts the first format into a second format conforming to a type of the target disk loaded on the optical disk drive and writes the data into the target disk.

2. The data duplicator according to claim 1, wherein the first format is an FAT, and either ISO9660 or an UDF is automatically selected for the second format according to the type of the target disk.

3. The data duplicator according to claim 1, wherein the control unit deletes the data stored in the first format in the hard disk drive after having written the data into the target disk.

4. The data duplicator according to claim 3, wherein, when a deletion command is input by way of a user operation unit, the control unit deletes the data stored in the hard disk drive; and, when the deletion command is not input by way of the user operation unit, the control unit leaves the data stored in the hard disk drive.

5. The data duplicator according to claim 1, further comprising:
a unit for storing a table pertaining to a correspondence between types of disks and format information, wherein the control unit reads a type of a disk recorded in a lead-in area of the target disk and reads format information corresponding to the acquired type of the disk through use of the table, thereby acquiring information about the second format.

6. The data duplicator according to claim 1, further comprising:
a user operation unit for inputting the information about the second format.

7. The data duplicator according to claim 1, wherein the source disk is a CD, and the target disk is a CD or a DVD.

8. The data duplicator according to claim 1, wherein the source disk is a DVD, and the target disk is a CD or a DVD.
